(19) United States
(12) Patent Application Publication
(10) Pub. No.: US 2007/0104822 A1
(43) Pub. Date: May 10, 2007

(54) Plasticizing apparatus for resin material

(75) Inventor: Yoshifumi Okabe, Mie (JP)

Correspondence Address: OLIFF & BERRIDGE, PLC, P.O. BOX 19928, ALEXANDRIA, VA, 22320, US

(73) Assignees: Autonetworks Technologies, Ltd., Yokkaichi-shi (JP); Sumitomo Wiring Systems, Ltd., Yokkaichi-shi (JP); Sumitomo Electric Industries, Ltd., Osaka-shi (JP)

(21) Appl. No.: 10/580,439

(22) PCT Filed: Jan. 4, 2005
(86) PCT No.: PCT/JP05/00162

§ 371 Date: Jun. 23, 2006

(30) Foreign Application Priority Data
Jun. 5, 2004 (JP) 2004-000165
Dec. 24, 2004 (JP) 2004-373560

(51) Int. Cl. B29C 45/74; B29C 45/53; B29C 47/80; B29B 7/82

(52) U.S. Cl. 425/550; 425/547; 425/200; 366/144

(57) ABSTRACT

To provide a plasticizing apparatus for resin material allowing downsizing of an injection molding apparatus while stabilizing a plastication state of a resin material without raising a heating temperature for a plasticizing barrel. On the inner surface of a plasticizing barrel 2 for plasticizing the resin material, one or more lines of a heat transfer piece 21 shaped like a ridge is/are disposed in a protrusion condition in a spiral or a straight line, and on the outer surface of the barrel 2, one or more lines of a heat receiving piece 22 is/are disposed in a protrusion condition in a spiral or a straight line, in the pitch of which, a heater 3 is fit, and in the vicinity of an opening 23 for feeding the resin material into the barrel 2, a radiating member 24 which radiates heat inside the barrel 2 into the outside air is disposed in a protrusion condition.

### TECHNICAL FIELD

The present invention relates to a plasticizing apparatus for resin material which is applied to an injection molding machine, an extrusion molding machine or the like, and more specifically relates to a plasticizing apparatus for resin material which is favorably employed in a small-size injection molding machine or extrusion molding machine.

### BACKGROUND ART

As a small-size plasticizing apparatus for resin material measuring about 400 mm or less in length such as a hand-held plasticizing apparatus used on a plate or a table-top plasticizing apparatus, often used in consideration of a matter of size thereof is a plunger-type plasticizing apparatus including a plasticizing mechanism for plasticizing pellets of a resin material only by the application of heat by means of a block heater without employing a screw-type plasticizing mechanism. Such a plunger-type plasticizing apparatus is constituted to plasticize and inject a resin material by feeding pellets of a thermoplastic resin material such as a PBT (polybutylene telephthalate) resin and a PP (polypropylene) resin into a section at the tail end of a plasticizing barrel, which is maintained below a melting temperature of the resin material, and squeezing the pellets into a section at the top end of the plasticizing barrel, to which a heater is mounted.

In order to secure portability and movability, it is required for the small-size plunger-type plasticizing apparatus to be downsized as a whole including the plasticizing barrel. In addition, also required is to ensure plasticizing capacity for the resin material in order not to reduce working efficiency. Accordingly, it is required that the resin material is efficiently plasticized while the plasticizing barrel is shortened. However, in a conventional simple constitution such that the plasticizing barrel made of a circular cylindrical metal tube having smooth inner and outer surfaces is wound externally with a heater, heat exchange effectiveness between the heater and the resin material is unfavorable. Even in the case of using a resin material of an injection-molding grade, a sufficient plastication state is not sometimes obtained in the plasticizing barrel.

Accordingly, in order to promote plastication of the resin material, two methods of raising a heating temperature and increasing a heating time are conceivable; however, the method of raising the heating temperature is not preferable since the rise in the heating temperature promotes thermal decomposition of the resin material. Meanwhile, in the method of increasing the heating time instead of raising the heating temperature, the time necessary for plastication of the resin material increases, so that there arises a need to increase a time interval between injection operations of the resin material. Therefore, this method cannot satisfy a demand from manufacturing premises to shorten the time interval between the injection operations, and is unfavorable from the viewpoint of productivity.

Incidentally, in order to downsize the plasticizing apparatus, it is necessary in view of design to reduce the distance between a section for heating and plasticizing the resin material in the plasticizing barrel, i.e., a section close to the top end of the plasticizing barrel to which the heater is mounted, and a section for receiving feed of the pellets of the resin material from a hopper or the like. In such a constitution, when the heating temperature of the heater is raised, heat generated by the heater is apt to be transferred to a section for receiving the feed of the resin material, so that a section for receiving the feed of the pellets of the resin material from the hopper and the hopper itself are apt to rise in temperature. Due to this, there may be cases where the resin material is softened and the pellets adhere to each other in the vicinity of the section and the hopper, forming a bridge, so that smooth feed of the resin material into the plasticizing barrel is hindered. In addition, since raising the heating temperature promotes thermal decomposition of the resin material, it is unfavorable from the viewpoint of the quality of obtained moldings.

In order to prevent formation of a bridge of the resin material to ensure smooth feed of the resin material, it is necessary that temperatures of at least the section for receiving the feed of the resin material from the hopper and its vicinity in the plasticizing barrel are maintained below the softening temperature of the resin material at least to some extent. However, addition of a cooling mechanism such as a water cooler which is conventionally and generally used results in upsizing or increase in weight of an injection apparatus and requires refrigerant piping or the like to be laid, impairing portability and movability of the injection apparatus.

Incidentally, as literatures concerning background art of the present invention, named are Japanese Examined Utility Model Registration No. 3007990, Japanese Patent Application Unexamined Publication No. Hei 9-11301, and Japanese Patent Application Unexamined Publication No. 2003-276068.

The present invention has been made in view of the above circumstances and has an object to overcome the above problems and to provide a plasticizing apparatus for resin material which can stabilize a plastication state of a resin material by improving the efficiency of heat transfer to the resin material without raising a heating temperature, can ensure downsizing of an injection molding apparatus without destabilizing the plastication state, or can smoothly feed the resin material by preventing formation of a bridge therein without degradation in portability and movability which is caused by upsizing, increase in weight, or the like of the apparatus.

### DISCLOSURE OF THE INVENTION

To achieve the objects and in accordance with the purpose of the present invention, according to the invention described in claim 1 is intended to provide a plasticizing apparatus for resin material including a plasticizing barrel for heating and plasticizing a resin material, which includes a heat source outside the plasticizing barrel and a heat transfer piece shaped like a ridge being formed on an inner surface of the plasticizing barrel into which the resin material is fed which transfers heat from the heat source outside the plasticizing barrel to the resin material in the plasticizing barrel.

Here, as described in claim 2, it is preferable that the heat transfer piece is formed into a spiral in a line or a plurality of lines along an axial line of the plasticizing barrel on the inner surface of the plasticizing barrel.

In addition, as described in claim 3, it is preferable that the plasticizing apparatus for resin material includes a heat receiving piece being formed in a protrusion condition on an outer surface of the plasticizing barrel which receives heat from a heater being the heat source outside the plasticizing barrel, and the heater is fit in contact with the outer surface of the plasticizing barrel and side surfaces of the heat receiving piece.

In this case, as described in claim 4, the heat receiving piece may be formed into a spiral in a line or a plurality of lines on the outer surface of the plasticizing barrel so that the heater is screw threaded in a pitch of the heat receiving piece to fit to be mountable and demountable on the outer surface of the plasticizing barrel.

In addition, as described in claim 5, the heat receiving piece may be formed in a plurality of approximately straight lines along the axial line on the outer surface of the plasticizing barrel so that the heater formed in a plurality of lines is slid in the heat receiving piece in a plurality of lines to fit to be mountable and demountable on the outer surface of the plasticizing barrel.

Here, as described in claim 6, it is preferable that the plasticizing apparatus for resin material includes a heat insulator being formed into a cylinder which covers the outer surface of the plasticizing barrel, and the heater is fit on an inner surface of the heat insulator, so that the heat insulator and the heater are fit integrally to be mountable and demountable on the outer surface of the plasticizing barrel.

In these cases, as described in claim 7, it is preferable that the plasticizing apparatus for resin material includes an opening being formed in a lateral wall of the plasticizing barrel for feeding the resin material and a radiating member being disposed in a protrusion condition on the outer surface of the plasticizing barrel in the vicinity of the opening which radiates heat in the plasticizing barrel.

Additionally, the invention described in claim 8 is intended to provide a plasticizing apparatus for resin material including a plasticizing barrel for heating and plasticizing a resin material, which includes an opening being formed in a lateral wall of the plasticizing barrel for feeding the resin material and a radiating member being formed on an outer surface of the plasticizing barrel in the vicinity of the opening which radiates heat in the plasticizing barrel.

According to the invention described in claim 1, pellets of the resin materials fed into the plasticizing barrel is plasticized by the heat from a heater fit to the outer surface of the plasticizing barrel. Here, the heat transfer piece is disposed in a protrusion condition on the inner surface of the plasticizing barrel, whereby a contacting area of the plasticizing barrel with the resin material is enlarged to improve the efficiency of heat transfer to the resin material. Accordingly, while a heating temperature of the heater is not set higher than necessary, the plastication of the resin material can be promoted and thermal decomposition of the resin material can be curbed. In addition, as a heating time can be reduced, working efficiency can be improved. Further, the plasticizing barrel can be shortened without destabilizing a plastication state of the resin material, so that downsizing of the plasticizing apparatus can be ensured.

Here, when the heat transfer piece is formed in a spiral as with the invention described in claim 2, the contacting area of the inner surface of the plasticizing barrel with the resin material is further increased, allowing the efficiency of heat transfer to be improved. In addition, the heat transfer piece formed in a spiral can apply shear on the resin material flowing in the plasticizing barrel, whereby plastication by the shear is added, allowing the plastication of the resin material to be promoted and the plastication state to be stabilized.

According to the invention described in claim 3, the heat generated by the heater is not only transferred from the outer surface of the plasticizing barrel but also transferred from the heat receiving piece formed on the outer surface of the plasticizing barrel, so that the contacting area of the plasticizing barrel with the heater is increased, allowing the efficiency of heat transfer of the heat generated by the heater to be improved. Accordingly, while the heating temperature of the heater is not set higher than necessary, the plastication of the resin material can be promoted and thermal decomposition of the resin material can be curbed. In addition, as the heating time can be reduced, working efficiency can be improved. Further, the plasticizing barrel can be shortened without destabilizing a plastication state of the resin material, so that downsizing of the plasticizing apparatus can be ensured, allowing portability and movability to be improved.

Here, when the heat receiving piece on the outer surface of the plasticizing barrel is formed in a spiral as with the invention described in claim 4, the heater is formed in a spiral in advance so that it can be fit to be mountable and demountable to the plasticizing barrel by screw threading. Accordingly, in making a change to the type, conditions of plastication or the like of the resin material, the heater can be easily replaced with another, allowing excellent handle ability. In addition, in the case of the heat receiving piece formed in one line, the plasticizing barrel can be heated by winding only one heater thereto, so that temperature control thereof is also made easier.

In addition, when the heat receiving piece is formed in a plurality of lines along an axial line of the plasticizing barrel as described in claim 5, the heater formed in a plurality of lines which are arranged to shape a cylinder can be slid to be mountable and demountable. Accordingly, in the same manner as the invention described in claim 4, in making a change to the type, conditions of plastication or the like of the resin material, the heater can be easily replaced with another, allowing excellent handleability.

Here, as described in claim 6, when a heat insulating member is formed into a cylinder and on the inner surface of which, the heater formed in a predetermined shape is fit in advance, the heat insulating member and the heater can be fit integrally to be mountable and demountable, allowing further excellent handleability.

When a radiating member is formed in the vicinity of the feed opening for the resin material as the invention described in claim 7, the heat transferred from the heater and the plasticized resin can be radiated into the outside air and the vicinity of the opening can be maintained below the temperature at which the surface of the resin material is softened, preventing unstable feed of the resin material resulting from the softening of the surface of the resin material.

According to the invention described in claim 8, the heat generated by the heater in order to plasticize the resin material is radiated into the outside air by the radiating member formed between the heater and the opening formed in a lateral wall of the plasticizing barrel in order to feed the pellets of the resin material into the plasticizing barrel. Owing to this, a rise in temperature in the vicinity of the opening is prevented, so that formation of a bridge resulting from softening of the resin material can be prevented. Therefore, smooth feed of the resin material can be achieved without causing upsizing, increase in weight of the plasticizing apparatus for resin material.

### BRIEF DESCRIPTION OF THE DRAWINGS

FIGS. 1A to 1C are sectional views diagrammatically showing structures of a main part of a plasticizing apparatus for resin material consistent with the embodiment of the present invention;

FIG. 2 is an external plan view showing a hand-held small-size plunger-type injection apparatus in which the plasticizing apparatus for resin material consistent with the present invention is incorporated; and

FIG. 3A is a plan view diagrammatically showing structures of a main part of a plasticizing apparatus for resin material consistent with the embodiment of the present invention, the view partially showing a sectional view, and FIG. 3B is an external perspective view showing a radiating member.

### BEST MODE FOR CARRYING OUT THE INVENTION

A detailed description of one preferred embodiment of the present invention will now be given with reference to the accompanying drawings.

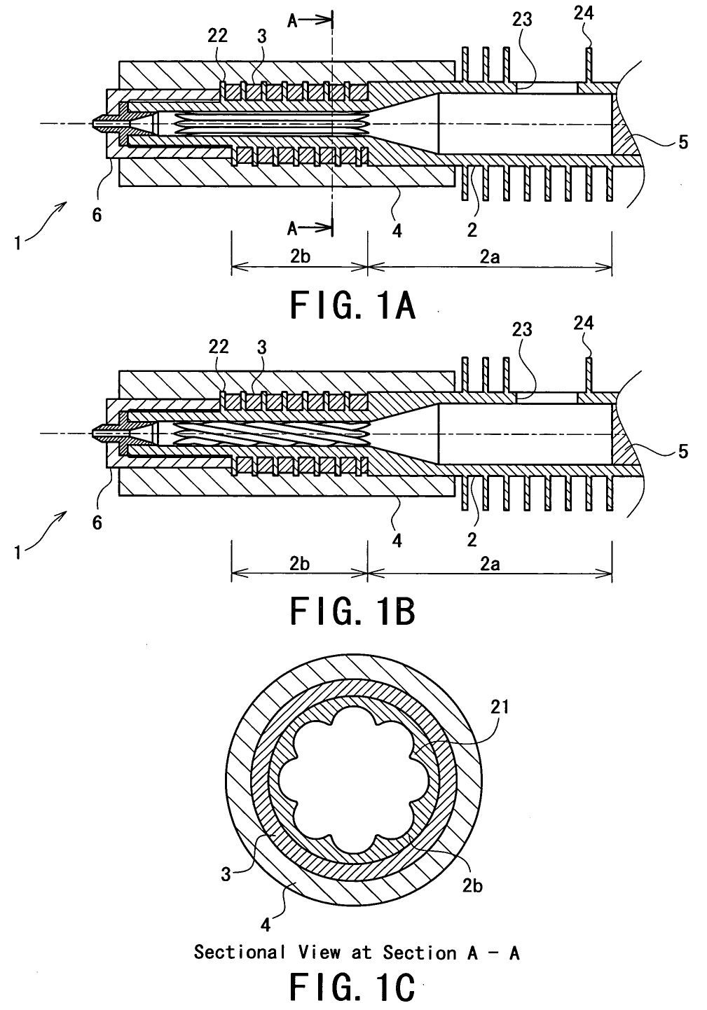

FIGS. 1A and 1B are sectional views diagrammatically showing structures of a main part of a plasticizing apparatus for resin material consistent with the first embodiment of the present invention, and FIG. 1C is a sectional view at the section A-A in FIG. 1A.

A plasticizing apparatus 1 consistent with the first embodiment includes a plasticizing barrel 2 for receiving feed of a resin material, a heater 3 which heats the resin material fed into the plasticizing barrel 2, and a heat insulating member 4 disposed on the outer surfaces of the plasticizing barrel 2 and the heater 3. At the tail end of the plasticizing barrel 2, a plunger 5 is disposed movable forward and backward, and the resin material is extruded by the plunger 5 and discharged from a discharge nozzle 6 disposed at the top end of the plasticizing barrel 2.

The plasticizing barrel 2 includes a feed section 2a for receiving the feed of the resin material from outside and a heating section 2b for heating the fed resin material using the heater 3 to plasticize.

On the inner surface of the heating section 2b in the plasticizing barrel 2, a ridge (in the present invention, referred to as a “heat transfer piece 21”) is formed in a line or in a plurality of lines as shown in FIG. 1c. The formation of the heat transfer piece 21 increases a contacting area with the resin material compared with a plasticizing barrel having a simply circular cylindrical structure, allowing the efficiency of heat transfer to the resin material to be improved. Accordingly, as the heating temperature of the heater 3 is not set higher than necessary, generation of thermal decomposition of the resin material can be curbed while plastication of the resin material is promoted, so that decline in the quality of resin moldings is not incurred. In addition, as a heating time can be reduced, working efficiency can be also improved. Further, the plasticizing barrel 2 is shortened while not destabilizing a plastication state of the resin material or while ensuring stabilization of the plastication state, so that downsizing of the plasticizing apparatus can be ensured.

It is favorable for the heat transfer piece 21 to be formed along an axial line of the plasticizing barrel 2 as shown in FIG. 1A in order not to hinder a flow of the resin material inside the heating section 2b. Alternatively, the heat transfer piece 21 may be formed in a spiral as shown in FIG. 1B. The heat transfer piece 21 formed in a spiral, of which a contacting area with the resin material increases, can further improve the efficiency of heat transfer. In addition to this, shear can be applied on the resin material flowing in the plasticizing barrel 2, whereby the plastication of the resin material can be promoted.

Additionally, while a shape in cross section of the heat transfer piece 21 is not especially limited, the heat transfer piece 21 is formed to project smoothly from the inner surface of the plasticizing barrel 21 so as not to let the resin material stay at the corner and the like of its base. For example, as shown in FIG. 1C, applicable is a configuration such that the heat transfer piece 21 is formed by cutting a plurality of half-round grooves (in the figure, 8 grooves) on the inner surface of the plasticizing barrel which is formed to have an approximately circular cross section. Such a configuration makes processing operation for forming the heat transfer piece 21 easy.

On the outer surface of the heating section 2b in the plasticizing barrel 2, a spiral flight (in the present invention, referred to as a “heat receiving piece 22”) is formed (in other words, a spiral flute is formed), and the heater 3 is fit so as to be wound in a pitch of the heat receiving piece 22 (in other words, inside the flute). A shape in cross section, dimensions, and the amount of pitch of the heat receiving piece 22 (or a shape in cross section and dimensions of the flute) are designed so that when the heater 3 is fit, the side surfaces of the heat receiving piece 22 and the outer surface of the plasticizing barrel 2 (or the side surfaces/side walls and the base end surface of the flute) come into contact with the heater 3 without clearance. Accordingly, the shape in cross section of the heat receiving piece 22 (or the flute), which is not limited to a quadrangle shown in FIGS. 1A and 1B, is designed in accordance with a shape in cross section and dimensions of the heater 3 as appropriate.

Here, the heater 3, if formed in a spiral, is screw threaded in a pitch of the heat receiving piece 22 of the heating section 2b, so that it can be fit to be mountable and demountable. While the number of lines of the heat receiving piece 21 is not specifically limited, especially if the heat receiving piece 22 in a spiral is formed in one line, only one heater may be fit by screw threading, so that the structure of the heating section 2b is not made complicated and temperature control is made easy. Besides, to the heater 3, various well-known heating elements and heating devices are applicable.

Then, the heat insulating member 4 is fit to cover the outer surface of the heating section 2b in the plasticizing barrel 2 and the heater 3. Here, the heat insulating member 4 may be formed into an approximate cylinder, to the inner surface of which the heater 3 formed in a spiral as mentioned above may be fit in advance. According to such a constitution, the heat insulating member 4 and the heater 3 can be integrally fit to be mountable and demountable in the manner of fitting screws, so that it is convenient in replacing the heater 3, and the like.

For another form of the heat receiving piece 22, a heat receiving piece in a line or in a plurality of lines may be provided in a protrusion condition along the axial line of the plasticizing barrel 2 (in other words, a flute in a line or in a plurality of lines may be formed along the axial line). In this case, a constitution can be such that the heater 3 of rod like shape is formed in a line or in a plurality of lines and fit along the line or between the respective lines of the heat receiving piece 22 (or inside the line(s) of the flute) In addition, when the heat receiving piece 22 (or the flute) is formed in a plurality of lines, a constitution can be such that the required number of rod like heaters 3 are arranged to shape a cylinder along the axial line in advance, and the heaters 3 are slid respectively in the heat receiving pieces 22 (or flutes) to be mountable and demountable. Also concerning the heat insulating member 4, in addition to the constitution that it is wound on the outer surface of the heating section 2b and the heater 3, by a constitution such that the heat insulating member 4 is formed into a cylinder, on the inner surface of which a plurality of heaters 3 are arranged along the axial line, the heaters 3 and the heat insulating member 4 can be slid to be mountable and demountable.

In the feed section 2a in the plasticizing barrel 2, a feed opening 23 for resin material is formed in a lateral wall while a radiating piece 24 is formed on the outer surface. The radiating piece 24 is for radiating heat into the outside air, the heat transferred from the heating section 3b and the resin material, and maintaining the temperature of the feed section 2a at or below the predetermined temperature. Specifically, the radiating piece 24 is formed like a fin, a pin or the like while its form is not limited as far as it can increase the outer surface of the feed section 2a in size to improve radiation effectiveness.

Incidentally, to a driving mechanism for the plunger 5, various driving mechanisms conventionally and generally used are applicable. In addition, to the discharge nozzle 6, a conventional and general nozzle used for injection molding is applicable. The discharge nozzle 6 may be either of an open type or of a shut off type, and the type is not limited.

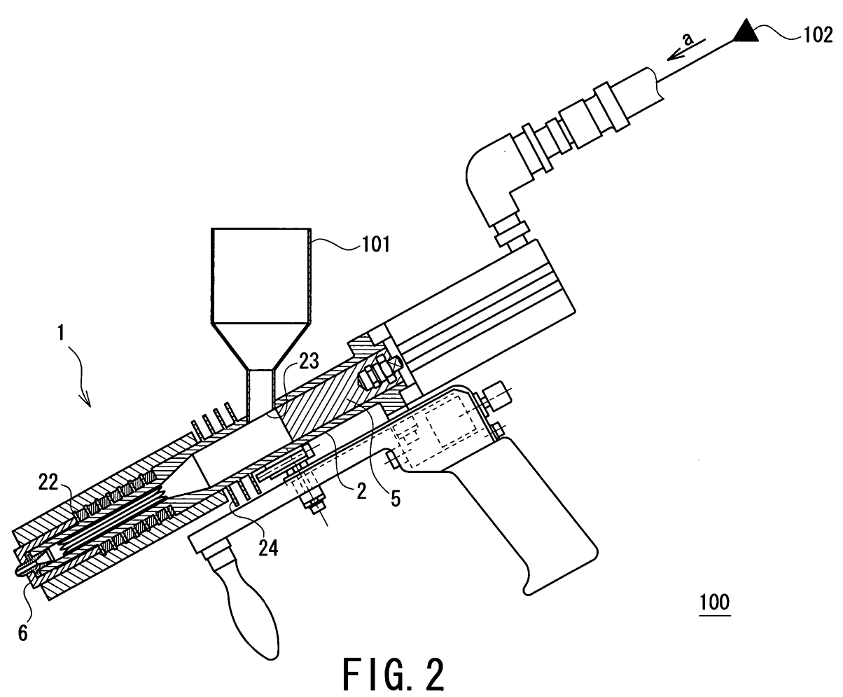

Next, a description will be given to an application example of the above-mentioned plasticizing apparatus. FIG. 2 is an external plan view showing a hand-held small-size plunger-type injection apparatus 100 in which the plasticizing apparatus 1 consistent with the above-mentioned embodiment is incorporated, the view partially including a sectional view. The plunger-type injection apparatus 100 is constituted so that a hopper 101 for reserving the resin material is fit to the feed section 2a in the plasticizing barrel 2 to communicate with the feed opening 23 for resin material, and the plunger 5 is driven by hydraulic pressure (indicated with the arrow a) supplied from an external hydraulic source 102.

The operation of the plunger-type injection apparatus 100 is as follows. Pellets of the resin material reserved in the hopper 101 are dropped from the feed opening 23 for resin material to be fed into the feed section 2a in the plasticizing barrel 2. Then, the plunger 5 is moved forward by the hydraulic pressure (the arrow a) to feed the resin material into the heating section 2b, in which the resin material is heated to be plasticized, and discharged from the discharge nozzle 6. The heat transfer piece 21 and the heat receiving piece 22 are formed respectively on the inner surface and the outer surface of the heating section 2b to improve the efficiency of heat transfer to the resin material, so that it is not necessary for the heating temperature of the heater 3 to be set higher than necessary. In addition, if the heat transfer piece 21 on the inner surface of the heating section 2b is formed in a spiral, shear is also added to the resin material and the plastication is further promoted.

Here, in order to stably feed the pellets of the resin material, it is desired to maintain the feed section 2a in the plasticizing barrel 2 low in temperature, specifically, at or below the temperature at which the surface of the resin material is softened. This is because if the surface of the resin material is softened inside the feed section 2a or the hopper 101, friction force between the pellets increases or the pellets adhere lightly to each other, hindering the resin material from being fed into the feed section 2a. In a case where the plasticizing apparatus 1 consistent with the present invention is applied, it is not necessary for the heating temperature of the heater 3 to be set higher than necessary, whereby the increase in temperature of the feed section 2a is curbed to a small extent. Therefore, without forcefully providing cooling by receiving supply of a cooling medium from the outside, the temperature of the feed section 2a can be maintained at or below the softening temperature of the resin material through radiation of heat from the radiating piece 24. Besides, a constitution may be such that the hopper 101 is formed of a material having high efficiency of heat transfer (e.g., a metal) to radiate the heat from the surface of the hopper 101 in addition to or instead of the radiating piece 24.

According to such a constitution, the heating section 2b in the plasticizing barrel 2 is shortened while maintaining or improving the plasticizing capacity for the resin material, so that the plasticizing apparatus 1 is downsized to be able to ensure the downsizing of the entire injection apparatus 100. In addition, compared with a constitution such that a cooling medium of water-cooling, oil-cooling or the like is employed, the injection apparatus 100 can be downsized. Therefore, the portability and movability of the injection apparatus 100 can be improved.

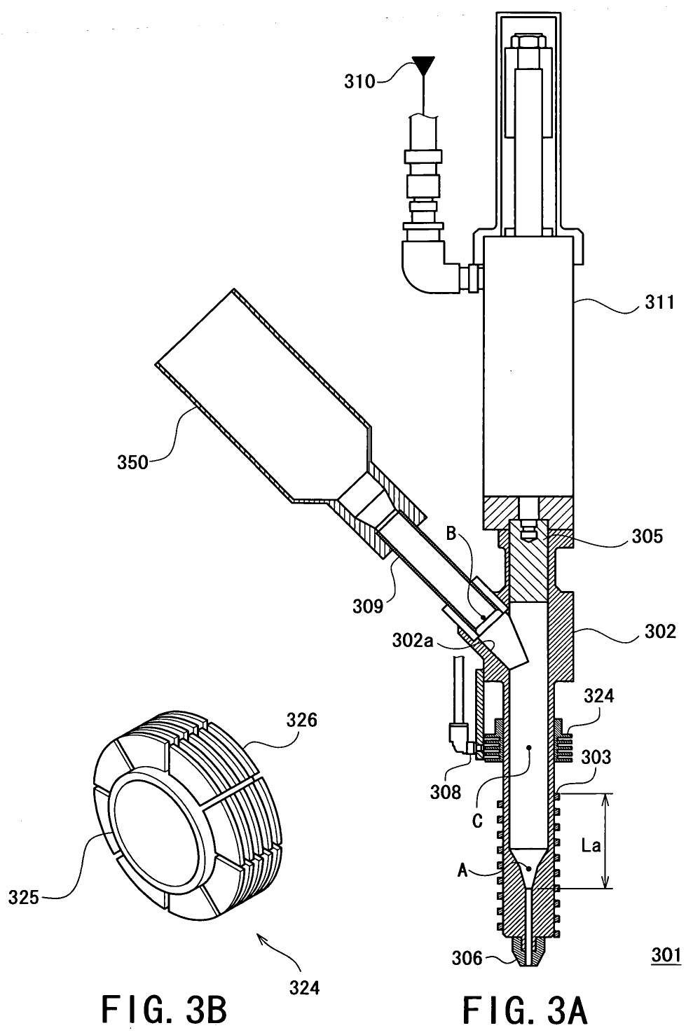

Next, a detailed description of the second preferred embodiment of the present invention will now be given with reference to FIGS. 3A and 3B. A plasticizing apparatus for resin material consistent with the present embodiment is, for example, the one of small size which is set on a table and capable of injecting the resin material of 20 cm³ or less per shot, preferably, about 10 cm³ or less per shot.

FIG. 3A is a plan view showing the structures of the main part of the plasticizing apparatus for resin material consistent with the present embodiment. In FIG. 3A, a driving mechanism 311 for a plunger and an air nozzle 308 are shown externally, and the other parts are shown cross-sectionally.

Firstly, a brief explanation of a constitution of a plasticizing apparatus 301 for resin material consistent with the second embodiment of the present invention will be given. As shown in FIG. 3A, the plasticizing apparatus 301 for resin material consistent with the present embodiment includes a plasticizing barrel 302 for plasticizing and injecting a resin material which is fed, a hopper 350 for reserving pellets of the resin material to be fed into the plasticizing barrel 302, a plunger 305 for depressing the plasticized resin material in the plasticizing barrel 302, a driving mechanism 311 for the plunger 305, and an injection nozzle 306 for injecting the resin material depressed by the plunger 305.

In addition, on the outer surface of the plasticizing barrel 302, a heater 303 which heats the resin material fed into the plasticizing barrel 302, a radiating member 324 which radiates heat of the plasticizing barrel 302 and the fed resin material into the outside air, and the air nozzle 308 for delivering an air blast in order to forcefully produce a current of air around the radiating member 324 are disposed.

Next, a detailed explanation of the respective members will be given. The plasticizing barrel 302 is an approximately cylindrical member formed of, for example, a metallic material. As shown in FIG. 3A, in the plasticizing barrel 302, a through-hole is formed along an axial line thereof. The plasticizing barrel 302 includes a section at the part of the plunger 305, where the internal diameter of the through-hole is formed larger, and a section in the vicinity of the injection nozzle 306, where the internal diameter of the through-hole is formed smaller. Then, the resin material is dropped into the section with the larger internal diameter, where the resin material is heated to be plasticized, and injected through the section with the smaller internal diameter and the injection nozzle 306. Besides, the shape in cross section of the through-hole of the plasticizing barrel 302 is not especially limited. In the present embodiment, it is formed into a simple circle to which an asperity or the like for increasing the inner surface area of the plasticizing barrel is not formed.

In addition, in a lateral wall of the plasticizing barrel 302, a feed section 302a for resin material is formed. In the feed section 302a for resin material, an opening by which the outside and the internal space of the plasticizing barrel 302 are communicated is formed, and to the feed section 302a, a feed pipe 309 for resin material communicating with the hopper 350 is connected. Thus, the plasticizing barrel 302 is constituted so that the resin material reserved in the hopper 350 can be fed into the plasticizing barrel 302 through the feed pipe 309 for resin material and the opening formed in the feed section 302a for resin material.

On the outer surface of the plasticizing barrel 302 in the vicinity of the top end thereof where the injection nozzle 306 is fit, a heater 303 which heats and plasticizes the resin material is fit. For a constitution in the present embodiment, a wire heater is applied. To be specific, the constitution is such that the wire heater is wound on the outer surface of the plasticizing barrel 302 to shape a coil over the predetermined length from the top end thereof where the injection nozzle 306 is disposed.

To the heater 303, applied is the one which has performance capabilities to maintain the temperature of the section in the plasticizing barrel 302 where the heater 303 is fit higher than the plasticizing temperature of the resin material by 70° C. or more. For example, in the case of applying PBT (polybutylene telephthalate) as the resin material, the one which has performance capabilities to raise the temperature up to 290° C. or more is applied, and in the case of applying TPS (a styrene thermoplastic elastomer material) as the resin material, the one which has performance capabilities to raise the temperature up to 280° C. or more is applied. To be specific, a wire heater manufactured by SAKAGUCHI E. H VOC CORP. (model number: U-9), and the like is applicable.

In the section with the larger internal diameter, the resin material fed into the plasticizing barrel 302 is heated to be plasticized mainly in the section around the outer surface of which the heater 303 is fit, i.e., the section indicated with the reference sign La in FIG. 3A. The internal volumetric capacity for the section indicated with the reference sign La is preferably 10 cm³ or less and may be about 20 cm³.

On the outer surface of the plasticizing barrel 302 between the heater 303 and the feed section 302a for resin material, the radiating member 324 is fit. The radiating member 324, which includes fins 326 for radiating heat, can radiate the heat of the plasticizing barrel 302 and the resin material into the outside air. By the radiation from the radiating member 324, temperatures of the inner surfaces of a section where the radiating member 324 is fit and a section between the feed section 302a for resin material and the section where the radiating member 324 is fit in the plasticizing barrel 302 are maintained below the predetermined temperature. The predetermined temperature is a temperature at which the surface of the resin material is not softened so as to form a bridge, and it is favorably lower than the softening temperature of the resin material by 20° C. or more though the temperature varies with the type of the resin material. Specifically, in the case of applying PBT as the resin material, the temperature is favorably at or below 90° C., and in the case of TPS, it is favorably at or below 80° C. Therefore, the fins 326 are favorably designed so that the surface area of the section exposed to the outside air in the radiating member 324 is made five times, more preferably seven times, as large as that of the section of the plasticizing barrel 302 to which the radiating member 324 is fit.

FIG. 3B is an external perspective view showing a structure of the radiating member 324. The radiating member 324 includes a base 325 which is formed into an approximate cylinder and the fins 326 which are approximately plate-shaped (in FIG. 3A, shown is a constitution such that the number of fins 326 is five). The fins 326 are constituted so as to be arranged at predetermined intervals along an axial line of the base 325. In addition, in each of the fins 326, a plurality of radial notches of the plate are formed while spaced circumferentially at approximately regular intervals. Besides, the radiating member 324 is formed integrally of a material having high efficiency of heat transfer such as aluminum.

As specific dimensions of the radiating member 324, when the external diameter of the plasticizing barrel 302 is 35 mm, it is favorable that the length of the base 325 along the axial line is 28 mm, the external diameter of the base 325 is 40 mm, the external diameter of the fins 326 is 58 mm, the number of the fins 326 is five, the width of notches formed in the fins 326 is 2 mm, and the number of notches is eight per fin. At this time, the thickness of each of the fins 326 is appropriately 2 mm and the interval between the surfaces of the respective fins 326 is appropriately 2 mm. As a consequence, the surface area of the external surface covered with the radiating member 324 in the plasticizing barrel 302 is about 3,080 mm², and the surface area of the section exposed to the outside air in the radiating member 324 becomes 18,000 mm², becoming about 5.8 times larger.

In addition, when the external diameter of the plasticizing barrel 302 is 40 mm, it is favorable that the length of the base 325 along the axial line is 30 mm and the external diameter of the base 325 is 45 mm, the external diameter of the fins 326 is 70 mm, the number of the fins 326 is five, the width of the notches formed in the fins 326 is 2 mm, and the number of notches is eight per fin. At this time, the thickness of each of the fins 326 is appropriately 2 mm and the interval between the surfaces of the respective fins 326 is appropriately 2.5 mm. As a consequence, the surface area of the external surface covered with the radiating member 324 in the plasticizing barrel 302 is about 3,780 mm², and the surface area of the section exposed to the outside air in the radiating member 324 becomes 27,500 mm², becoming about 7.3 times larger.

In these cases, it is favorable that the radiating member 324 is fit at least 10 mm apart from the heater 303.

Incidentally, though the constitution in the present embodiment is such that the radiating member 324 formed separately from the plasticizing barrel 302 is fit thereto, a constitution such that the fins 326 is formed integrally with the plasticizing barrel 302 is also allowed.

Then, in the vicinity of the radiating member 324, the air nozzle 308 for forcefully producing a current of air around the radiating member 324 to promote radiation is disposed. The air nozzle 308 includes a nozzle hole having a cross-sectional area of about 3 mm² or more, and a flow rate of gas the air nozzle 308 can inject is 0.05 m³/hr at smallest and an air velocity at the nozzle hole is 0.5 m/s at lowest, and preferably, the flow rate is 0.08 m³/hr or more and the air velocity at the nozzle hole is 1.0 m/s or more. Then, the air nozzle 308 is constituted to be able to deliver an air blast toward the middle of a group of the fins of the radiating member 324 in parallel with a direction of the surfaces of the fins. To be specific, as shown in FIGS. 3A and 3B, in the case of the radiating member 324 provided with five pieces of fins 326, the air nozzle 308 is constituted so as to deliver an air blast toward the center in a direction of the thickness of the fin which is located thirdly from the end.

To the driving mechanism 311 for the plunger 305, a hydraulic driving mechanism or other various driving mechanisms which are conventionally and generally used are applicable. In the present embodiment, the driving mechanism 311 is constituted so as to receive supply of hydraulic pressure from a hydraulic source 310 which is disposed outside. In addition, to the injection nozzle 306, an injection nozzle which is conventionally and generally used in injection molding and extrusion molding is applicable. Hence, a detailed description of them is omitted. Besides, the injection nozzle 306, the type and the structure of which are not limited, may be either of an open type or of a shut off type.

The operation of the plasticizing apparatus for resin material having the above-described constitutions is as follows. The plasticizing barrel 302 is heated using the heater 303. At this time, a temperature of the inner surface of the plasticizing barrel 302 in the vicinity of a boundary between the sections with the through-hole of larger internal diameter and with the through-hole of smaller internal diameter (i.e., a temperature of the inner surface in the vicinity of the point A in FIG. 3A) is maintained higher than the plasticizing temperature of the resin material by about 70° C. For example, in the case of applying PBT as the resin material, it is maintained close to 290° C., and in the case of TPS, it is maintained close to 280° C. In this state, the pellets of the resin material reserved in the hopper 350 are fed into the plasticizing barrel 302 through the feed pipe 309 for resin material and the feed section 302a for resin material. The fed pellets of the resin material are heated and plasticized. Then, the plunger 305 is actuated to depress the plasticized resin material, which is injected from the injection nozzle 306.

At this time, a part of the heat generated by the heater 303 moves toward the feed section 302a for resin material; however, as the radiating member 324 is fit between the heater 303 and the feed section 302a for resin material, the heat is to be radiated through the radiating member 324 into the atmosphere. Accordingly, even though the temperature of the inner surface of the plasticizing barrel 302 in the vicinity of the boundary between the sections with the through-hole of larger internal diameter and with the through-hole of smaller internal diameter is maintained higher than the plasticizing temperature of the resin material by about 70° C., temperatures of the section where the radiating member 324 is fit and of the inner surface of the feed pipe 309 for resin material can be maintained below the plasticizing temperature of the resin material by 20° C. or more; whereby formation of a bridge resulting from a softened surface of the pellets of the resin material can be prevented, allowing smooth feed of the pellets of the resin material.

Owing to the above-described constitutions, stabilization of feed of the resin material can be ensured while maintaining or improving plasticizing capability thereof, and consequently, the plasticizing barrel 302 is downsized to be able to ensure downsizing of the entire injection apparatus 301. In addition, it is not necessary to add a setup for circulating a cooling medium of water-cooling, oil-cooling or the like, so that portability and movability of the injection apparatus is not impaired.

### Implementation Example

Next, a description of an Implementation Example of the present invention will now be given. Injection of the resin material was conducted using the plasticizing apparatus consistent with the second embodiment of the present invention. Hereinafter, the description is given referring to FIG. 3A.

Firstly, a constitution of the apparatus is described. In the plasticizing barrel 302, the external diameter of a section where the heater 303 and the radiating member 324 are fit is 35 mm , and the internal diameter of a section of larger internal diameter is 25 mm. The plasticizing barrel 302 is made of a tool steel (S45C) For the heater 303, the above-mentioned wire heater manufactured by SAKAGUCHI E. H VOC CORP. (model number: U-9) was employed. A heat-producing part of the wire heater has the shape in cross section of 3.4 mm square, and is 1,400 mm in length and 850 W in capacity. Then, the wire heater is wound around the plasticizing barrel 302 to shape a coil over 94 mm in length from the top end thereof at the part where the injection nozzle 306 is fit. Accordingly, the internal volumetric capacity of the section indicated with the reference sign La in the figure is about 10 cm³.

The radiating member 324 is made of aluminum. The length of the base 325 along the axial line is 28 mm and the external diameter of the base 325 is 40 mm. The external diameter of the fins 326 is 58 mm and the number of the fins 326 is five, the width of the notches formed in the fins 326 is 2 mm, and the number of the notches is eight per fin. Additionally, the thickness of each of the fins 326 is 2 mm and the interval between the surfaces of the respective fins 326 is 2 mm. The surface area of the external surface covered with the radiating member 324 in the plasticizing barrel 302 is about 3,080 mm², and the surface area of the section exposed to the outside air in the radiating member 324 becomes 18,000 mm², becoming about 5.8 times larger. Then, the radiating member 324 is fit so that the end part of the base 325 facing the injection nozzle 306 is placed in a position 114 mm apart from the top end of the plasticizing barrel 302 to which the injection nozzle 306 is fit. In other words, the space between the end part of the heater 303 facing the plunger 305 and the end part of the base 325 of the radiating member 324 facing the injection nozzle 306 is about 20 mm.

The air nozzle 308 includes the nozzle hole of 3 mm in diameter, from which an air blast can be delivered in parallel with a direction of the surfaces of the fins.

Next, conditions for the implementation are described. The plasticizing barrel 302 was heated using the heater 303 and the temperature of the inner surface of the plasticizing barrel 302 at the point A was maintained at 280° C. Then, two conditions were adapted: one is such that an air blast at a velocity of 1 m/s and at a flow rate of 0.08 m³/hr was delivered toward the radiating member 324 using the air nozzle 308, and the other is such that the air nozzle 308 was not used and no air blast was delivered. For the resin material, TPS was used, the softening temperature of which is 80° C. Then, 25.5 cm³ of TPS was dropped into the plasticizing barrel 302.

Then, a temperature of the inner surface of the plasticizing barrel 302 in the section to which the radiating member 324 is fit (i.e., a temperature at the point C in FIG. 3A) and a temperature of the inner surface of the feed pipe 309 for resin material very close to the end part thereof at a part of the feed section 302a for resin material (i.e., a temperature at the point B in FIG. 3A) were measured. Besides, for the temperature measurement at the respective points, a thermocouple was used.

As a result of conducting the temperature measurement on the above-described conditions, the temperature of the inner surface of the plasticizing barrel 302 at the point C was 71° C. when an air blast was delivered toward the radiating member 324 and 100° C. when no air blast was delivered. In addition, the temperature at the point B was 51° C. when an air blast was delivered toward the radiating member 324 and 90° C. when no air blast was delivered. As the softening temperature of TPS is 80° C., the temperature in the vicinity of the feed section 302a for resin material was able to be maintained below the softening temperature of the resin material by 20° C. or more. Consequently, the pellets of the resin material are not softened so as to form a bridge in the vicinity of the feed section 302a for resin material or in the feed pipe 309 for resin material, allowing smooth feed of the pellets of the resin material into the plasticizing barrel 302.

Meantime, in a case where the radiating member 324 was not fit, the temperature at the point C was about 200° C., and the temperature at the point B was about 120° C. Due to this, the temperature of the feed section 302a for resin material and the temperature of the inner surface of the feed pipe 309 for resin material in the vicinity of the feed section 302a for resin material were not able to be maintained below the softening temperature of the resin material by 20° C. or more. Therefore, it is considered that when the radiating member 324 is not employed, the resin material is softened to form a bridge when feeding the resin material, impairing smooth feed thereof.

As described above, according to the constitutions consistent with the present invention, the smooth feed of the resin material can be conducted by preventing the formation of a bridge while not resulting in upsizing or an increase in weight of the plasticizing apparatus.

The foregoing description of the preferred embodiments and the implementation example of the invention has been presented for purposes of illustration and description with reference to the drawings; however, it is not intended to limit the invention to the preferred embodiments, and modifications and variations are possible as long as they do not deviate from the principles of the invention.

1. A plasticizing apparatus for resin material including a plasticizing barrel for heating and plasticizing a resin material, the plasticizing apparatus for resin material comprising:
a heat source outside the plasticizing barrel; and
a heat transfer piece shaped like a ridge, being formed on an inner surface of the plasticizing barrel into which the resin material is fed, which transfers heat from the heat source outside the plasticizing barrel to the resin material in the plasticizing barrel.

2. The plasticizing apparatus for resin material according to claim 1, wherein the heat transfer piece is formed into a spiral in a line or a plurality of lines along an axial line of the plasticizing barrel on the inner surface of the plasticizing barrel.

3. The plasticizing apparatus for resin material according to claim 1, further comprising a heat receiving piece being formed in a protrusion condition on an outer surface of the plasticizing barrel, which receives heat from a heater being the heat source outside the plasticizing barrel,
wherein the heater is fit in contact with the outer surface of the plasticizing barrel and side surfaces of the heat receiving piece.

4. The plasticizing apparatus for resin material according to claim 3, wherein the heat receiving piece is formed into a spiral in a line or a plurality of lines on the outer surface of the plasticizing barrel, and the heater is screw threaded in a pitch of the heat receiving piece to fit to be mountable and demountable on the outer surface of the plasticizing barrel.

5. The plasticizing apparatus for resin material according to claim 3, wherein the heat receiving piece is formed in a plurality of approximately straight lines along the axial line on the outer surface of the plasticizing barrel, and the heater formed in a plurality of lines is slid in the heat receiving piece in a plurality of lines to fit to be mountable and demountable on the outer surface of the plasticizing barrel.

6. The plasticizing apparatus for resin material according to claim 3, further comprising a heat insulator, being formed into a cylinder, which covers the outer surface of the plasticizing barrel, wherein the heater is fit on an inner surface of the heat insulator, so that the heat insulator and the heater are fit integrally to be mountable and demountable on the outer surface of the plasticizing barrel.

7. The plasticizing apparatus for resin material according to claim 1, further comprising:
an opening, being formed in a lateral wall of the plasticizing barrel, for feeding the resin material; and
a radiating member, being disposed in a protrusion condition on the outer surface of the plasticizing barrel in the vicinity of the opening, which radiates heat in the plasticizing barrel.

8. A plasticizing apparatus for resin material including a plasticizing barrel for heating and plasticizing a resin material, the plasticizing apparatus for resin material comprising:
an opening, being formed in a lateral wall of the plasticizing barrel, for feeding the resin material; and
a radiating member, being formed on an outer surface of the plasticizing barrel in the vicinity of the opening, which radiates heat in the plasticizing barrel.
